(19) United States
(12) Patent Application Publication
(10) Pub. No.: US 2025/0029789 A1
(43) Pub. Date: Jan. 23, 2025

(54) MULTILAYER CERAMIC CAPACITOR

(71) Applicant: Murata Manufacturing Co., Ltd., Nagaokakyo-shi (JP)

(72) Inventors: Kazuhiro NISHIBAYASHI, Nagaokakyo-shi (JP); Yuko KAWASAKI, Nagaokakyo-shi (JP)

(21) Appl. No.: 18/905,342

(22) Filed: Oct. 3, 2024

Related U.S. Application Data
(63) Continuation of application No. PCT/JP2023/037366, filed on Oct. 16, 2023.

(30) Foreign Application Priority Data
Dec. 19, 2022 (JP) 2022-202430

(51) Int. Cl. H01G 4/30; H01G 4/008; H01G 4/012; H01G 4/12; H01G 4/232

(52) U.S. Cl. CPC H01G 4/30; H01G 4/008; H01G 4/012; H01G 4/12; H01G 4/232

(57) ABSTRACT

A multilayer ceramic capacitor includes an inner layer portion including a first-main-surface-side region, a second-main-surface-side region, and a central region between the first-main-surface-side region and the second-main-surface-side region. In the central region, dielectric layers each between internal electrodes adjacent to each other in a lamination direction and exposed at a same surfaces are in contact with the external electrode at contact portions, and an average of thicknesses of the dielectric layers at the contact portions is referred to as an average thickness Lc. In at least one of the first-main-surface-side region or the second-main-surface-side region, dielectric layers each between internal electrodes adjacent to each other in the lamination direction and exposed at the same surface are in contact with the external electrodes at contact portions, and a thickness of the dielectric layer at each contact portion is referred to as a thickness Ls and Ls<0.75Lc is satisfied.

### CROSS REFERENCE TO RELATED APPLICATIONS

This application claims the benefit of priority to Japanese Patent Application No. 2022-202430 filed on Dec. 19, 2022 and is a Continuation application of PCT Application No. PCT/JP2023/037366 filed on Oct. 16, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

A multilayer ceramic capacitor including a ceramic multilayer body and external electrodes formed on outer sides of the multilayer body is mounted on a board, while having the external electrodes connected to the board. Therefore, when stress is caused by, for example, distortion or vibration of the board or a difference in thermal expansion between the board and the multilayer body, the stress is transmitted to the multilayer body via the external electrodes, and may cause a crack inside the multilayer body. To address this, there is a known technique to form voids in the external electrodes so that the voids relax external stress, thereby preventing development of a crack (see Japanese Unexamined Patent Application, Publication No. H5-3132).

### SUMMARY OF THE INVENTION

However, an increase in the capacitance of the multilayer ceramic capacitor involves thinning the external electrodes. As a result, moisture may infiltrate into the multilayer body via the voids, and the insulation resistance of the multilayer ceramic capacitor may deteriorate. In particular, this phenomenon becomes remarkable in an outermost layer portion where the external electrodes have a smallest thickness.

Example embodiments of the present invention provide multilayer ceramic capacitors each capable of reducing the likelihood of moisture infiltration through the external electrodes.

A multilayer ceramic capacitor according to an example embodiment includes a multilayer body including an inner layer portion in which a plurality of dielectric layers with internal electrodes provided thereon are laminated, the multilayer body including two main surfaces including a first main surface provided on one side in a lamination direction and a second main surface provided on an other side in the lamination direction, two lateral surfaces respectively provided on both sides in a width direction intersecting with the lamination direction, and two end surfaces respectively provided on both sides in a length direction intersecting with the lamination direction and the width direction, and external electrodes respectively provided on the end surfaces and the lateral surfaces of the multilayer body, the dielectric layers including first dielectric layers and second dielectric layers that are alternately laminated with each other, the internal electrodes including end-surface-exposure internal electrodes that are exposed at least at the end surfaces, and lateral-surface-exposure internal electrodes that are exposed at least at the lateral surfaces, each of the first dielectric layers including the end-surface-exposure internal electrode thereon, each second dielectric layer including the lateral-surface-exposure internal electrode thereon, each end-surface-exposure internal electrode including a counter portion and a lead-out portion that extends from the counter portion, each lateral-surface-exposure internal electrode including a counter portion and a lead-out portion that extends from the counter portion, the counter portion of the end-surface-exposure internal electrode and the counter portion of the lateral-surface-exposure internal electrode being opposed to each other, in which the inner layer portion includes a first-main-surface-side region, a second-main-surface-side region, and a central region between the first-main-surface-side region and the second-main-surface-side region, in the central region, the dielectric layers each located between the internal electrodes that are adjacent to each other in the lamination direction and are exposed at a same one of the surfaces of the multilayer body are in contact with the external electrode at contact portions, and an average of thickness of the dielectric layers at the contact portions is referred to as an average thickness Lc, in at least one of the first-main-surface-side region or the second-main-surface-side region, the dielectric layers each located between the internal electrodes that are adjacent to each other in the lamination direction and are exposed at the same one of the surfaces of the multilayer body are in contact with the external electrode at contact portions, and a thickness of the dielectric layer at each contact portion is referred to as a thickness Ls, and a relationship represented by Ls<0.75Lc is satisfied.

Multilayer ceramic capacitors according to example embodiments of the present invention are each capable of reducing the likelihood of moisture infiltration through the external electrodes.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1.

FIG. 2 is a cross-sectional view of the multilayer ceramic capacitor 1 according to a first example embodiment of the present invention, taken along line II-II in FIG. 1.

FIG. 3 is a cross-sectional view of the multilayer ceramic capacitor 1 according to the first example embodiment of the present invention, taken along line III-III in FIG. 1.

FIG. 4 is an exploded perspective view of a multilayer body 2.

FIG. 5 is a flowchart illustrating a method of manufacturing the multilayer ceramic capacitor 1.

FIG. 6 is a cross-sectional view of a multilayer ceramic capacitor 100 according to a second example embodiment of the present invention, taken along line II-II in FIG. 1.

FIG. 7 is a cross-sectional view of the multilayer ceramic capacitor 100 according to the second example embodiment of the present invention, taken along line III-III in FIG. 1.

### DETAILED DESCRIPTION OF THE EXAMPLE EMBODIMENTS

### First Example Embodiment

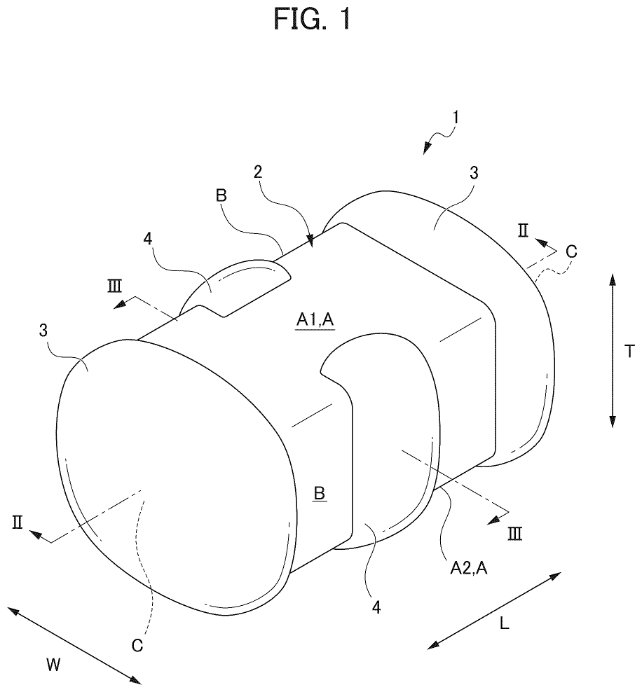

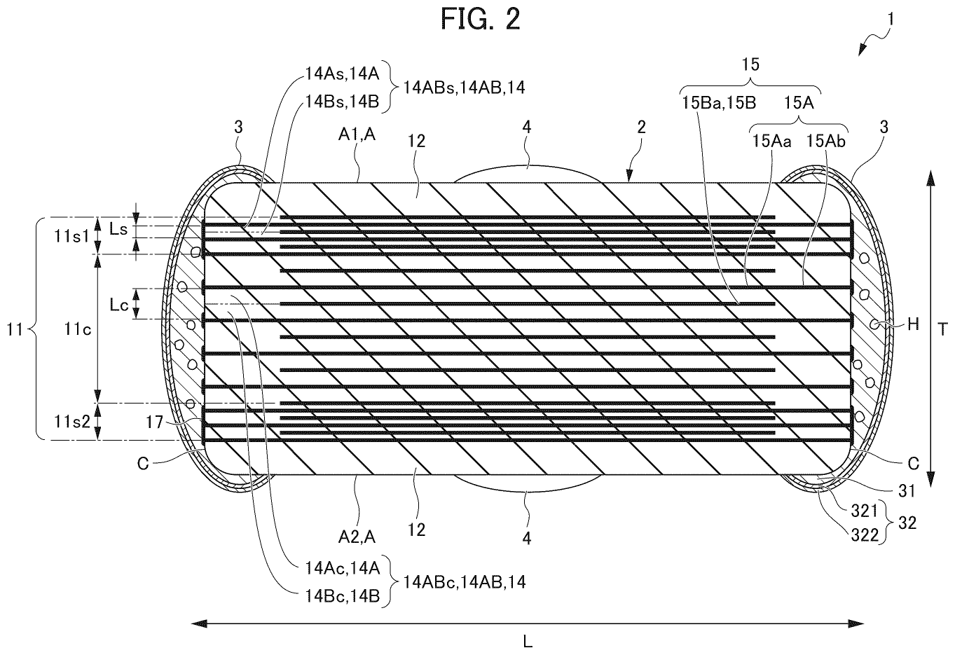

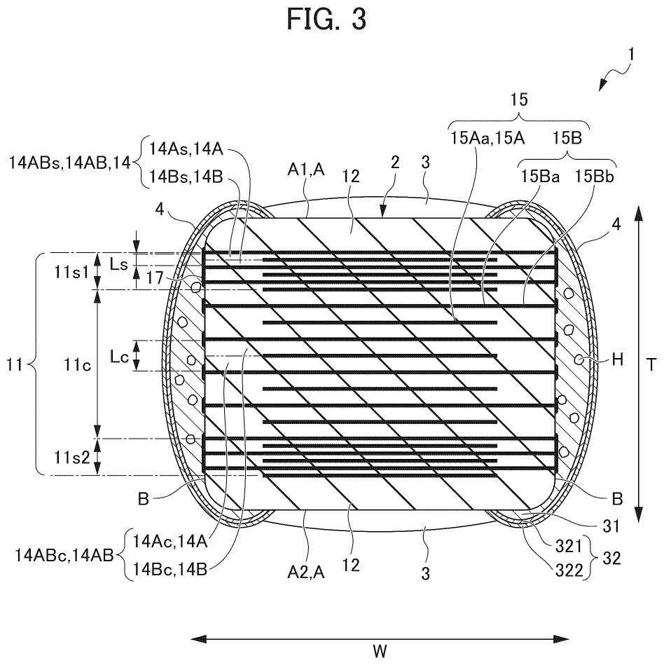

A multilayer ceramic capacitor 1 according to a first example embodiment of the present invention will be described below. FIG. 1 is a schematic perspective view of the multilayer ceramic capacitor 1. FIG. 2 is a cross-sectional view of the multilayer ceramic capacitor 1 according to the first example embodiment, taken along line II-II in FIG. 1. FIG. 3 is a cross-sectional view of the multilayer ceramic capacitor 1 according to the first example embodiment, taken along line III-III in FIG. 1.

### Multilayer Ceramic Capacitor 1

The multilayer ceramic capacitor 1 has a three-terminal structure, and includes a multilayer body 2, end-surface external electrodes 3 provided on both end surfaces C of the multilayer body 2 in a length direction L, and lateral-surface external electrodes 4 provided on both lateral surfaces B of the multilayer body 2 in a width direction W. The multilayer body 2 includes an inner layer portion 11 in which dielectric layers 14 and internal electrodes 15 are laminated, and outer layer portions 12.

In the present specification, the orientation of the multilayer ceramic capacitor 1 is described using the following terms. A direction in which the dielectric layers 14 and the internal electrodes 15 are laminated in the multilayer ceramic capacitor 1 is referred to as a lamination direction T. A direction which intersects with the lamination direction T and in which the pair of end-surface external electrodes 3 are provided is referred to as the length direction L. A direction intersecting with both the length direction L and the lamination direction T is referred to as the width direction W. In the present example embodiment, the lamination direction T, the length direction L, and the width direction W are orthogonal to one another.

Furthermore, in the following description, among the six outer surfaces of the multilayer body 2, a pair of outer surfaces on both sides in the lamination direction T are referred to as main surfaces A, a pair of outer surfaces extending in the lamination direction T on both sides in the width direction W are referred to as the lateral surfaces B, and a pair of outer surfaces extending in the lamination direction T on both sides in the length direction L are referred to as the end surfaces C. The main surfaces A include a first main surface A1 and a second main surface A2.

### Multilayer Body 2

The multilayer body 2 includes the inner layer portion 11 and the outer layer portions 12 disposed on both sides of the inner layer portion 11 in the lamination direction T. The multilayer body 2 preferably has rounded corners and ridges. Each corner is where three surfaces of the multilayer body 2 meet one another, and each ridge is where two surfaces of the multilayer body 2 meet each other.

### Outer Layer Portion 12

The outer layer portions 12 each include a dielectric layer having a constant thickness and disposed on the side of the inner layer portion 11 adjacent to the main surface A. Each outer layer portion 12 includes a same material as that of the dielectric layers 14 in the inner layer portion 11.

### Inner Layer Portion 11

In the inner layer portion 11, the plurality of dielectric layers 14 and the plurality of internal electrodes 15 are laminated in the lamination direction T.

### Internal Electrode 15

The internal electrodes 15 are preferably made of a metal material representative examples of which include Ni, Cu, Ag, Pd, a Ag—Pd alloy, Au, etc.

The internal electrodes 15 include a plurality of end-surface-exposure internal electrodes 15A and a plurality of lateral-surface-exposure internal electrodes 15B that are alternately arranged with each other. The end-surface-exposure internal electrode 15A and the lateral-surface-exposure internal electrode 15B are collectively referred to as the internal electrode(s) 15 when it is unnecessary to particularly distinguish from each other.

### End-Surface-Exposure Internal Electrode 15A

The end-surface-exposure internal electrodes 15A extend between the end surfaces C of the multilayer body 2 opposite to each other in the length direction L, and are spaced apart by a certain distance from the lateral surfaces B opposite to each other in the width direction W. Each end-surface-exposure internal electrode 15A includes an end-surface counter portion 15Aa that is located in a central portion between the end surfaces C, and end-surface lead-out portions 15Ab that extend from the end-surface counter portion 15Aa to both end surfaces C, respectively. The end-surface lead-out portions 15Ab respectively extend to both end surfaces C of the multilayer body 2, are exposed at the end surfaces C, and are connected to the end-surface external electrodes 3 provided on both end surfaces C of the multilayer body 2 opposite to each other in the length direction L.

### Lateral-Surface-Exposure Internal Electrode 15b

Each lateral-surface-exposure internal electrode 15B is slightly smaller than a cross section of the multilayer body 2 and is spaced apart by a certain distance from both end surfaces C opposite to each other in the length direction L. Each lateral-surface-exposure internal electrode 15B includes a lateral-surface counter portion 15Ba that is located in a central portion between the lateral surfaces B, and lateral-surface lead-out portions 15Bb that extend from the lateral-surface counter portion 15Ba to both lateral surfaces B, respectively. The lateral-surface lead-out portions 15Bb respectively extend to both lateral surfaces B of the multilayer body 2, are exposed at the lateral surfaces B, and are connected to the lateral-surface external electrodes 4 provided on both lateral surfaces B of the multilayer body 2 opposite to each other in the width direction W.

The end-surface counter portions 15Aa and the lateral-surface counter portions 15Ba are opposed to each other, and define a capacitor portion. In the following description, the end-surface counter portion 15Aa and the lateral-surface counter portion 15Ba are collectively referred to as a counter portion(s) 15a when it is unnecessary to particularly distinguish from each other. The end-surface lead-out portion 15Ab and the lateral-surface lead-out portion 15Bb are collectively referred to as a lead-out portion(s) 15b when it is unnecessary to particularly distinguish from each other. In addition, in the multilayer body 2, a region in which the counter portions 15a are disposed is referred to as a counter region, and a region in which the end-surface lead-out portions 15Ab or the lateral-surface lead-out portions 15Bb are disposed is referred to as a lead-out region.

### Dielectric Layer 14

The dielectric layers 14 include a ceramic material.

As the ceramic material, a dielectric ceramic including BaTiO₃ as a main component is used, for example. Alternatively, a material including, in addition to the main component, at least one subcomponent selected from a Mn compound, a Fe compound, a Cr compound, a Co compound, a Ni compound, or the like may be used as the ceramic material.

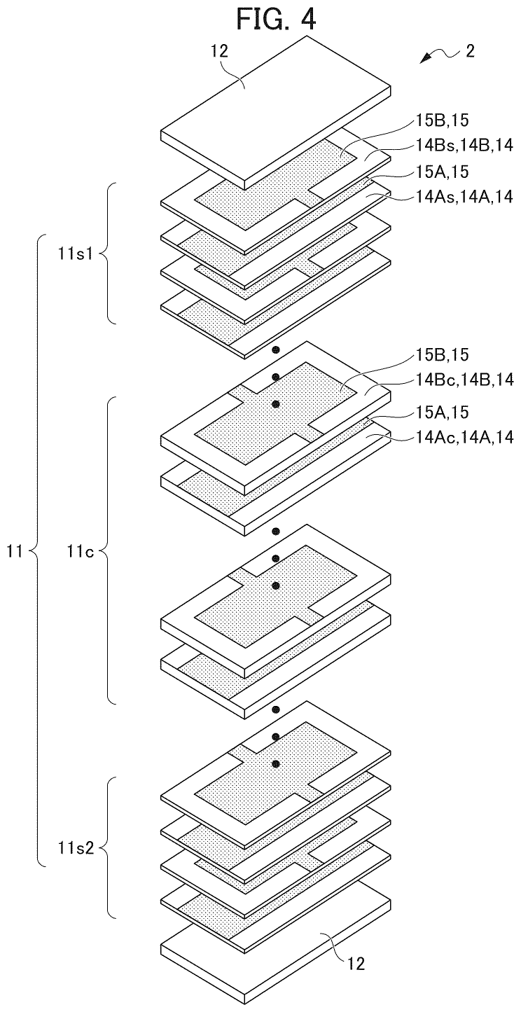

The dielectric layers 14 include first dielectric layers 14A and second dielectric layers 14B that are alternately laminated with each other. FIG. 4 is an exploded perspective view of the multilayer body 2. On each first dielectric layer 14A, the end-surface-exposure internal electrode 15A, which is exposed at the end surfaces C, is disposed as the internal electrode 15. On each second dielectric layer 14B, the lateral-surface-exposure internal electrode 15B, which is exposed at the lateral surfaces B, is disposed as the internal electrode 15.

As illustrated in FIGS. 2, 3, and 4, the inner layer portion 11 includes a first-main-surface-side region 11s1 situated close to the first main surface A1, a second-main-surface-side region 11s2 situated close to the second main surface A2, and a central region 11c situated between the first-main-surface-side region 11s1 and the second-main-surface-side region 11s2.

As illustrated in FIG. 4, the first and second dielectric layers arranged in the first-main-surface-side region 11s1 and the second-main-surface-side region 11s2 are denoted by the reference signs 14As and 14Bs, respectively. The first and second dielectric layers arranged in the central region 11c are denoted by the reference signs 14Ac and 14Bc, respectively. Each of the first and second dielectric layers 14As and 14Bs is thinner than each of the first and second dielectric layers 14Ac and 14Bc, and the thickness of the former is not more than about 0.75 times the thickness of the latter, for example.

### Lc

Referring to FIGS. 2 and 3, in the central region 11c in the lead-out region, the dielectric layers each disposed between the internal electrodes 15 that are adjacent to each other in the lamination direction T and are exposed at the same surface are denoted by the reference sign 14ABc. The dielectric layers 14ABc are in contact with the end-surface external electrodes 3 at contact portions, and an average thickness of the dielectric layers 14ABc at the contact portions is referred to as an average thickness Lc.

The thickness Lc of the dielectric layer 14ABc between the internal electrodes 15 is the total thickness of two dielectric layers 14Ac and 14Bc laminated on each other.

### Ls

Referring to FIGS. 2 and 3, in the first-main-surface-side region 11s1 and the second-main-surface-side region 11s2 in the lead-out region, the dielectric layers each disposed between the internal electrodes 15 that are adjacent to each other in the lamination direction T and are exposed at the same surface are denoted by the reference sign 14ABs. The thickness of the dielectric layer 14Abs is referred to as a thickness Ls.

The thickness Ls of the dielectric layer 14ABs between the internal electrodes 15 is the total thickness of two dielectric layers 14As and 14Bs laminated on each other.

In the multilayer ceramic capacitor 1 of the present example embodiment, the thickness Ls of the dielectric layer 14ABs between the internal electrodes 15 in each of the first-main-surface-side region 11s1 and the second-main-surface-side region 11s2 is smaller than the thickness Lc of the dielectric layer 14ABc between the internal electrodes 15 in the central region 11c. In the present example embodiment, the relationship represented by Ls<0.75Lc is satisfied, for example.

However, example embodiments of the present invention are not limited to the above configuration. The multilayer ceramic capacitor 1 may be configured such that one of the first-main-surface-side region 11s1 and the second-main-surface-side region 11s2 satisfies Ls<0.75Lc, for example.

The first-main-surface-side region 11s1 and the second-main-surface-side region 11s2 each include, from the layer closest to the respective main surface A, a plurality of the dielectric layers 14ABs having a thickness Ls satisfying Ls<0.75Lc, for example, and the dielectric layers 14ABs are continuously arranged. When the total number of the internal electrodes 15 is defined as K, and the number of the internal electrodes 15 in each of the first-main-surface-side region 11s1 and the second-main-surface-side region 11s2 is defined as m, the relationship represented by m≤K/3 is satisfied.

### End-Surface External Electrode 3

As illustrated in FIG. 2, the end-surface external electrodes 3 are respectively disposed on both end surfaces C of the multilayer body 2. The end-surface external electrodes 3 are connected to the end-surface lead-out portions 15Ab of the end-surface-exposure internal electrodes 15A. Each end-surface external electrode 3 covers not only the end surface C but also a portion of each main surface A and a portion of each lateral surface B that are adjacent to the end surface C.

### Lateral-Surface External Electrode 4

As illustrated in FIG. 3, the lateral-surface external electrodes 4 are respectively disposed on both lateral surfaces B of the multilayer body 2. The lateral-surface external electrodes 4 are connected to the lateral-surface lead-out portions 15Bb of the lateral-surface-exposure internal electrodes 15B. Each lateral-surface external electrode 4 covers not only a portion of the lateral surface B but also a portion of each main surface A that is adjacent to the lateral surface B.

The end-surface external electrodes 3 and the lateral-surface external electrodes 4 each include a base electrode layer 31 and a plated layer 32 formed on the base electrode layer 31. The base electrode layer 31 includes Cu as a main component. The plated layer 32 includes a nickel (Ni) plated layer 321 formed on the base electrode layer 31 and a tin (Sn) plated layer 322 formed on the Ni plated layer 321.

As illustrated in FIGS. 2 and 3, the end-surface external electrodes 3 and the lateral-surface external electrodes 4 include a plurality of voids H. Each of the end-surface external electrodes 3 and the lateral-surface external electrodes 4 is thinner in portions thereof on and near the main surfaces A opposed to each other in the lamination direction T than in a central portion thereof in the lamination direction T. Therefore, also on the inner layer portion 11, each of the end-surface external electrodes 3 and the lateral-surface external electrodes 4 is thinner in the first-main-surface-side region 11s1 and the second-main-surface-side region 11s2 than the central region 11c. For example, the thickness of each of the end-surface external electrodes 3 and the lateral-surface external electrodes 4 is about 10 μm or less in the first-main-surface-side region 11s1 and the second-main-surface-side region 11s2, and is greater than about 10 μm or more and about 60 μm or less in the central region 11c, for example.

As illustrated in FIGS. 2 and 3, interdiffusion layers 17 are formed at junctions between the internal electrodes 15 and the end-surface external electrodes 3 and junctions between the internal electrodes 15 and the lateral-surface external electrodes 4. The interdiffusion layers 17 are arranged with the internal electrodes 15 interposed therebetween and have substantially the same dimension in the lamination direction T.

In the central region 11c, since the thickness Lc of the dielectric layer 14ABc disposed between the internal electrodes 15 is large and greater than the dimension of the interdiffusion layer 17, the interdiffusion layers 17 are discontinuous with each other.

On the other hand, in the first-main-surface-side region 11s1 and the second-main-surface-side region 11s2, the thickness Ls of the dielectric layer 14ABs disposed between the internal electrodes 15 is less than the thickness Lc, and Ls<0.75Lc is satisfied, for example. Since Ls is smaller than the dimension of the interdiffusion layer 17, the interdiffusion layers 17 are continuous with each other.

### Method of Manufacturing Multilayer Ceramic Capacitor 1

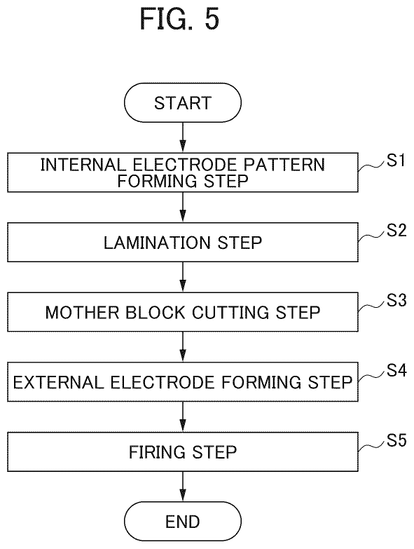

Next, a non-limiting example of a method of manufacturing the multilayer ceramic capacitor 1 according to the present example embodiment will be described. FIG. 5 is a flowchart illustrating the example method of manufacturing the multilayer ceramic capacitor 1.

### Internal Electrode Pattern Forming Step S1

A conductive paste is applied in the shape of the end-surface-exposure internal electrode 15A to each ceramic green sheet that is to form the first dielectric layer 14A. Likewise, the conductive paste is applied in the shape of the lateral-surface-exposure internal electrode 15B to each ceramic green sheet that is to form the second dielectric layer 14B.

The ceramic green sheet is a strip-shaped sheet prepared by forming a ceramic slurry including ceramic powder, a binder, and a solvent into a sheet shape on a carrier film using a die coater, a gravure coater, a micro-gravure coater, or the like.

At this time, as illustrated in the exploded perspective view of the multilayer body 2 in FIG. 4, the ceramic green sheets to be arranged in the first-main-surface-side region 11s1 and the second-main-surface-side region 11s2 are made thinner than the ceramic green sheets to be arranged in the central region 11c: specifically, the thickness of the former is no more than about 0.75 times the thickness of the latter, for example.

The end-surface-exposure internal electrodes 15A and the lateral-surface-exposure internal electrodes 15B are formed by way of, for example, printing such as screen printing, gravure printing, relief printing, or the like.

### Lamination Step S2

The ceramic green sheets to form the first dielectric layers 14A having the end-surface-exposure internal electrodes 15A disposed thereon and the ceramic green sheets to form the second dielectric layers 14B having the lateral-surface-exposure internal electrodes 15B disposed thereon are alternately laminated with each other. Specifically, laminates of the thin ceramic green sheets to be positioned in the first-main-surface-side region 11s1 and the second-main-surface-side region 11s2 are respectively stacked on the upper and lower sides of a laminate of the thick ceramic green sheets to be positioned in the central region 11c. Subsequently, ceramic green sheets for the outer layer portions are further stacked on the upper and lower sides of the resultant stack, and thermocompression bonding is performed, thereby forming a mother block.

### Mother Block Cutting Step S3

Next, the mother block is cut and divided in the length direction L and the width direction W to produce a plurality multilayer bodies 2 having a rectangular parallelepiped shape.

### External Electrode Forming Step S4

Next, the end-surface external electrodes 3 are formed on both end surfaces C of the multilayer body 2, and the lateral-surface external electrodes 4 are formed on both lateral surfaces B. The end-surface lead-out portions 15Ab of the end-surface-exposure internal electrodes 15A are connected to the end surface external electrodes 3. Each end-surface external electrode 3 is formed so as to cover not only the end surface C but also a portion of each main surface A and a portion of each lateral surface B that are adjacent to the end surface C. The lateral-surface lead-out portions 15Bb of the lateral-surface-exposure internal electrodes 15B are connected to the lateral-surface external electrodes 4. Each lateral-surface external electrode 4 is formed so as to cover not only a portion of the lateral surface B but also a portion of each main surface A that is adjacent to the lateral surface B.

The end-surface external electrodes 3 and the lateral surface external electrodes 4 are formed by applying an external electrode paste including metal particles including, for example, Cu as a main component, an inorganic binder that is, for example, glass particles, an additive (e.g., a plasticizer, a dispersant), an organic solvent, etc.

### Firing Step S5

Heating is performed for a predetermined time in a nitrogen atmosphere at a set firing temperature. As a result, the end-surface external electrodes 3 and the lateral-surface external electrodes 4 are fired onto the multilayer body 2. In this step, the metal particles form some gaps, the glass particles melt and fill the gaps, and the locations where the glass particles have been present turn into the voids H.

As illustrated in FIGS. 2 and 3, on the inner layer portion 11, the end-surface external electrodes 3 and the lateral-surface external electrodes 4 are thinner in the first-main-surface-side region 11s1 and the second-main-surface-side region 11s2 than in the central region 11c.

Furthermore, the interdiffusion layers 17 are formed at the junctions between the internal electrodes 15 and the end-surface external electrodes 3 and the junctions between the internal electrodes 15 and the lateral-surface external electrodes 4. In the central region 11c, the thickness Lc of the dielectric layer 14ABc between the internal electrodes 15 is large. Therefore, the interdiffusion layers 17 are discontinuous with each other between the internal electrodes 15 and the end-surface external electrodes 3 and between the internal electrodes 15 and the lateral-surface external electrodes 4.

In the first-main-surface-side region 11s1 and the second-main-surface-side region 11s2, the thickness Ls of the dielectric layer 14ABs between the internal electrodes 15 is less than the thickness Lc, and Ls<0.75Lc is satisfied, for example. Therefore, the interdiffusion layers 17 are continuous with each other between the internal electrodes 15 and the end-surface external electrodes 3 and between the internal electrodes 15 and the lateral-surface external electrodes 4.

Here, in a case where the end-surface external electrodes 3 and the lateral-surface external electrodes 4 are thin, moisture may infiltrate through the voids H to make the insulation resistance of the multilayer ceramic capacitor 1 deteriorate. In particular, the likelihood of this phenomenon increases in the vicinities of the main surfaces A where the end-surface external electrodes 3 and the lateral-surface external electrodes 4 have a smallest thickness.

However, in the first-main-surface-side region 11s1 and the second-main-surface-side region 11s2, the interdiffusion layers 17 formed between the internal electrodes 15 and the end-surface external electrodes 3 are continuous with each other, and the interdiffusion layers 17 between the internal electrodes 15 and the lateral-surface external electrodes 4 are continuous with each other. The interdiffusion layers 17 prevent or reduces infiltration of moisture through the voids H, thereby reducing the possibility of deterioration of the insulation resistance of the multilayer ceramic capacitor 1. Thus, the multilayer ceramic capacitor capable of reducing the likelihood of moisture infiltration through the external electrodes can be provided.

Moreover, in the present example embodiment, since the distance between the internal electrodes 15 is short in the first-main-surface-side region 11s1 and the second-main-surface-side region 11s2, a DC resistance value can be lowered.

### Modification

In the present example embodiment described above, the internal electrodes 15 arranged in the first-main-surface-side region 11s1 and the second-main-surface-side region 11s2 all have the same thickness or substantially the same thickness, but the present invention is not limited to this configuration. For example, the internal electrodes 15 arranged in the first-main-surface-side region 11s1 and the second-main-surface-side region 11s2 may be thicker than the internal electrodes 15 arranged in the central region 11c.

In this case, the thickness of the internal electrodes 15 in the first-main-surface-side region 11s1 and the second-main-surface-side region 11s2 is preferably about 1.1 times the thickness of the internal electrodes 15 in the central region 11c, for example. An increase in the thickness of the internal electrodes 15 makes it possible to more reliably make the interdiffusion layers 17 continuous with each other.

In addition, although the multilayer ceramic capacitor 1 of the present example embodiment is of the three-terminal type, the present invention is not limited to this type. Example embodiments of the present invention are applicable to a two-terminal multilayer ceramic capacitor.

### Second Example Embodiment

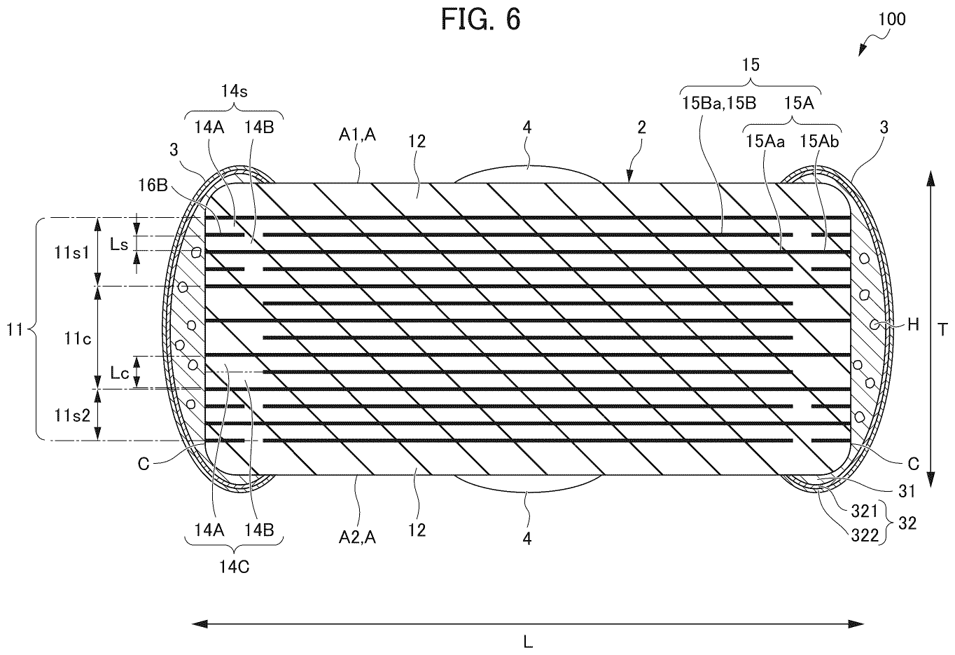

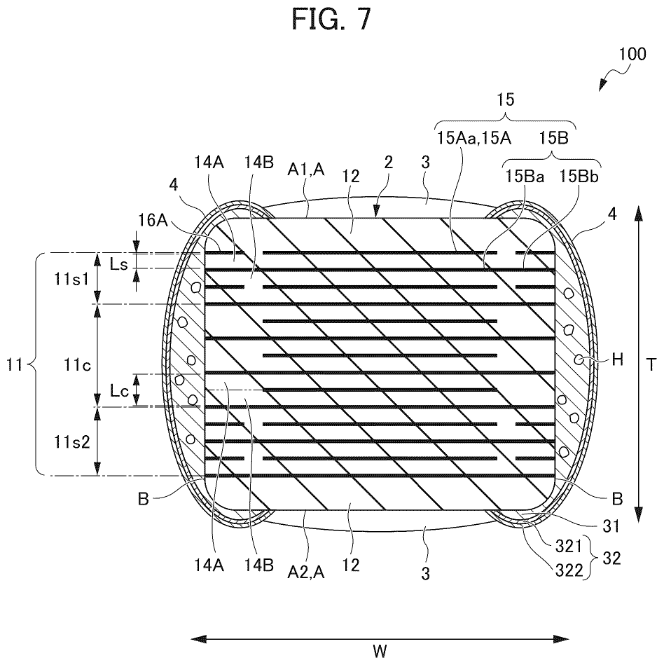

A multilayer ceramic capacitor 100 according to a second example embodiment of the present invention will be described below. FIG. 1 applies to the second example embodiment. FIG. 6 is a cross-sectional view of the multilayer ceramic capacitor 100 according to the second example embodiment, taken along line II-II in FIG. 1. FIG. 7 is a cross-sectional view of the multilayer ceramic capacitor 100 according to the second example embodiment, taken along line III-III in FIG. 1.

In the following description of the multilayer ceramic capacitor 100 of the second example embodiment, the same or similar components to those of the multilayer ceramic capacitor 1 of the first example embodiment are denoted by the same reference signs. In addition, a description of the same or similar components will be omitted.

Unlike the first example embodiment, in the second example embodiment, the thickness of each of the first and second dielectric layers 14As and 14Bs in the first-main-surface-side region 11s1 and the second-main-surface-side region 11s2 is equal to the thickness of each of the first and second dielectric layers 14Ac and 14Bc in the central region 11c.

In the second example embodiment, as illustrated in FIG. 7, lateral-surface-exposure auxiliary internal electrodes 16A as auxiliary internal electrodes 16 are arranged in the first-main-surface-side region 11s1 and the second-main-surface-side region 11s2. Each lateral-surface-exposure auxiliary internal electrode 16A is disposed on a portion of the first dielectric layer 14A having the end-surface-exposure internal electrode 15A disposed thereon and that is adjacent to the lateral surface B. Each lateral-surface-exposure auxiliary internal electrode 16A is spaced apart from the end-surface-exposure external electrode 15A. Each lateral-surface-exposure auxiliary internal electrode 16A is exposed at the lateral surface B and is opposed to the lateral-surface lead-out portion 15Bb of the lateral-surface-exposure internal electrode 15B adjacent to the end-surface-exposure internal electrode 15A in the lamination direction T.

As illustrated in FIG. 6, end-surface-exposure auxiliary internal electrodes 16B as the auxiliary internal electrodes 16 are each disposed on a portion of the second dielectric layer 14B having the lateral-surface-exposure internal electrode 15B disposed thereon and that is adjacent to the end surface C.

Each end end-surface-exposure auxiliary internal electrode 16B is spaced apart from the lateral-surface-exposure internal electrode 15B. Each end-surface-exposure auxiliary internal electrode 16B is exposed at the end surface C and is opposed to the end-surface lead-out portion 15Ab of the end-surface-exposure internal electrode 15A adjacent to the lateral-surface-exposure internal electrode 15B in the lamination direction T.

Therefore, in the first-main-surface-side region 11s1 and the second-main-surface-side region 11s2, each of the dielectric layers 14, which are disposed between the internal electrodes 15 adjacent to each other in the lamination direction T and exposed at the same end surface C, has a thickness Ls that is equal to the thickness of one dielectric layer 14B between the end-surface lead-out portion 15Ab and the end-surface-exposure auxiliary internal electrode 16B.

Each of the dielectric layers 14, which are disposed between the internal electrodes 15 adjacent to each other in the lamination direction T and exposed at the same lateral surface B, has a thickness Ls that is equal to the thickness of one dielectric layer 14A between the lateral-surface lead-out portion 15Bb and the lateral-surface-exposure auxiliary internal electrode 16A.

In the central region 11c, each of the dielectric layers 14, which are disposed between the internal electrodes 15 adjacent to each other in the lamination direction T and exposed at the same end surface C, has a thickness Lc that is equal to the thickness of a dielectric layer 14c between the end-surface lead-out portions 15Ab and is equal to the sum of the thicknesses of two dielectric layers, for example.

Therefore, Ls=0.75Lc and Ls<0.75Lc are satisfied, for example.

As in the first example embodiment, the second example embodiment also includes interdiffusion layers 17 formed at the junctions between the internal electrodes 15 and the end-surface external electrodes 3 and the junctions between the internal electrodes 15 and the lateral-surface external electrodes 4.

In the central region 11c, since the dielectric layers 14c between the internal electrodes 15 each have the large thickness Lc, the interdiffusion layers 17 are discontinuous with each other between the internal electrodes 15 and the end-surface external electrodes 3 and between the internal electrodes 15 and the lateral-surface external electrodes 4.

In the first-main-surface-side region 11s1 and the second-main-surface-side region 11s2, since the thickness Ls of the dielectric layers 14c between the internal electrodes 15 is smaller than the thickness Lc, the interdiffusion layers 17 are continuous with each other between the internal electrodes 15 and the end-surface external electrodes 3 and between the internal electrodes 15 and the lateral-surface external electrodes 4.

Therefore, the second example embodiment also reduces the possibility of deterioration of the insulation resistance of the multilayer ceramic capacitor 100 that can be caused by moisture infiltration through the voids H, and thus, the multilayer ceramic capacitor capable of reducing the likelihood of moisture infiltration through the external electrodes can be provided.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion in which a plurality of dielectric layers with internal electrodes provided thereon are laminated, the multilayer body including two main surfaces including a first main surface provided on one side in a lamination direction and a second main surface provided on an other side in the lamination direction, two lateral surfaces respectively provided on both sides in a width direction intersecting with the lamination direction, and two end surfaces respectively provided on both sides in a length direction intersecting with the lamination direction and the width direction; and
external electrodes respectively provided on the end surfaces and the lateral surfaces of the multilayer body;
the dielectric layers including first dielectric layers and second dielectric layers that are alternately laminated with each other, the internal electrodes including end-surface-exposure internal electrodes that are exposed at least at the end surfaces, and lateral-surface-exposure internal electrodes that are exposed at least at the lateral surfaces, each of the first dielectric layers including the end-surface-exposure internal electrode thereon, each second dielectric layer including the lateral-surface-exposure internal electrode thereon, each end-surface-exposure internal electrode including a counter portion and a lead-out portion that extends from the counter portion, each lateral-surface-exposure internal electrode including a counter portion and a lead-out portion that extends from the counter portion, the counter portion of the end-surface-exposure internal electrode and the counter portion of the lateral-surface-exposure internal electrode being opposed to each other; wherein
the inner layer portion includes a first-main-surface-side region, a second-main-surface-side region, and a central region between the first-main-surface-side region and the second-main-surface-side region;
in the central region, the dielectric layers each located between the internal electrodes that are adjacent to each other in the lamination direction and are exposed at a same one of the surfaces of the multilayer body are in contact with the external electrode at contact portions, and an average of thickness of the dielectric layers at the contact portions is referred to as an average thickness Lc;
in at least one of the first-main-surface-side region or the second-main-surface-side region, the dielectric layers each located between the internal electrodes that are adjacent to each other in the lamination direction and are exposed at the same one of the surfaces of the multilayer body are in contact with the external electrode at contact portions, and a thickness of the dielectric layer at each contact portion is referred to as a thickness Ls; and
a relationship represented by Ls<0.75Lc is satisfied.

2. The multilayer ceramic capacitor according to claim 1, wherein a plurality of the dielectric layers with the thickness Ls at the contact portions with the external electrode are continuously arranged.

3. The multilayer ceramic capacitor according to claim 1, wherein
a total number of the internal electrodes is defined as K;
a number of the internal electrodes in each of the first-main-surface-side region and the second-main-surface-side region is defined as m, and a relationship represented as m≤K/3 is satisfied.

4. The multilayer ceramic capacitor according to claim 1, wherein each of the internal electrodes in the first-main-surface-side region and the second-main-surface-side region is thicker than each of the internal electrodes in the central region.

5. The multilayer ceramic capacitor according to claim 1, wherein
in the first-main-surface-side region and the second-main-surface-side region, the internal electrodes include lateral-surface-exposure auxiliary internal electrodes or end-surface-exposure auxiliary internal electrodes;
each of the lateral-surface-exposure auxiliary internal electrodes is provided on the first dielectric layer while being spaced apart from the end-surface-exposure internal electrode on the first dielectric layer, is exposed at the lateral surface, and is opposed to the lead-out portion of the lateral-surface-exposure internal electrode on the second dielectric layer that is adjacent to the first dielectric layer in the lamination direction;
each of the end-surface-exposure auxiliary internal electrodes is provided on the second dielectric layer while being spaced apart from the lateral-surface-exposure internal electrode on the second dielectric layer, is exposed at the end surface, and is opposed to the lead-out portion of the end-surface-exposure internal electrode provided on the first dielectric layer that is adjacent to the second dielectric layer in the lamination direction;
the average thickness Ls is an average thickness of the dielectric layers each located between the lateral-surface-exposure auxiliary internal electrode on the first dielectric layer and the lateral-surface-exposure internal electrode on the second dielectric layer; or
the average thickness Ls is an average thickness of the dielectric layers each located between the end-surface-exposure auxiliary internal electrode on the second dielectric layer and the end-surface-exposure internal electrode on the first dielectric layer.

6. The multilayer ceramic capacitor according to claim 1, wherein the multilayer ceramic capacitor has a three terminal structure.

7. The multilayer ceramic capacitor according to claim 1, wherein the multilayer body includes rounded corners and ridges.

8. The multilayer ceramic capacitor according to claim 1, wherein in each of the first-main-surface-side region and the second-main-surface-side region, the relationship represented by Ls<0.75Lc is satisfied.

9. The multilayer ceramic capacitor according to claim 1, wherein the external electrodes include end-surface external electrodes and lateral-surface external electrodes.

10. The multilayer ceramic capacitor according to claim 1, wherein each of the external electrodes includes a base electrode layer and a plated layer.

11. The multilayer ceramic capacitor according to claim 10, wherein the base electrode layer includes Cu and the plated layer includes Ni and tin.

12. The multilayer ceramic capacitor according to claim 1, wherein each of the external electrodes includes voids.

13. The multilayer ceramic capacitor according to claim 1, wherein a thickness of each of the external electrodes in the first-main-surface-side region and the second-main-surface-side region is about 10 μm or less, and a thickness of each of the external electrodes in the central region is about 10 μm or more and about 60 μm or less.

14. The multilayer ceramic capacitor according to claim 1, wherein interdiffusion layers are provided at junctions between the internal electrodes and the external electrodes.

15. The multilayer ceramic capacitor according to claim 14, wherein the interdiffusion layers are discontinuous with each other.

16. The multilayer ceramic capacitor according to claim 1, wherein a thickness of each of the first and second dielectric layers in the first-main-surface-side region and the second-main-surface-side region is equal to a thickness of each of the first and second dielectric layers in the central region.

17. The multilayer ceramic capacitor according to claim 1, wherein Ls=0.75Lc and Ls<0.75Lc are satisfied.
